(19) United States
(12) Patent Application Publication
(10) Pub. No.: US 2010/0027030 A1
(43) Pub. Date: Feb. 4, 2010

(54) ANGULAR DISPLACEMENT SENSOR

(75) Inventor: Bernhard Theodoor Sikkens, Almere (NL)

Correspondence Address: OBLON, SPIVAK, MCCLELLAND MAIER & NEUSTADT, L.L.P., 1940 DUKE STREET, ALEXANDRIA, VA, 22314, US

(73) Assignee: Paccus Interfaces B.V., AH Almere (NL)

(21) Appl. No.: 12/443,235

(22) PCT Filed: Sep. 7, 2007
(86) PCT No.: PCT/NL2007/050442

§ 371 Date: May 5, 2009

(30) Foreign Application Priority Data
Sep. 27, 2006 (NL) NL 1032584

(51) Int. Cl. G01B 11/00

(52) U.S. Cl. 356/614

(57) ABSTRACT

A device for measuring angular displacement, including a light emitter and a light receiver, which are angularly rotatable relative to each other, wherein the light receiver includes light-sensitive pixels arranged in a pattern on a chip surface, on which light emitted by or via the light emitter is incident in dependence on the aforesaid angle of rotation, and wherein the pattern at least forms part of a circular arc pattern. The device does not make exacting demands on the precision with which the light emitter and the light receiver rotate relative to each other, whilst an accurate end result is obtained by a compact device that can be produced at lower cost.

The present invention relates to a device for measuring angular displacement, which device is also known by the name of: angular displacement sensor.

The present invention further relates to a method for measuring angular displacement and to a light receiver integrated on a chip for use in said angular displacement sensor.

Such angular displacement sensors are generally known. They are used inter alia in computer games, in particular high-end computer games, but also in professional areas, for example as manipulators for industrial applications in automatic systems and for robots inter alia for medical use.

The known sensors have the disadvantage that they are generally costly and voluminous and, when used in professional areas, are not capable of measuring angular displacements with a sufficient degree of precision or only at high additional costs.

The object of the present invention is to provide an improved device for accurately measuring angular displacements in which the above disadvantages are at least alleviated.

In order to accomplish that object, the device according to the invention is characterised in that it comprises a light emitter and a light receiver, which are angularly rotatable relative to each other, wherein the light receiver is provided with light-sensitive pixels arranged in a pattern on a chip surface, on which light from or via the light emitter is incident in dependence on the aforesaid angle of rotation, and wherein said pattern at least forms part of a circular arc pattern.

The method according to the invention is characterised in that an angular displacement between a light emitter and a light receiver which are angularly rotatable relative to each other is measured, wherein light from the light emitter is projected onto light-sensitive pixels arranged in a pattern on a chip surface in dependence on the aforesaid angle of rotation, and wherein said pattern forms part of a circular arc pattern.

An advantage of the device and the method according to the invention is that so far a low-play mechanical rotation and bearing system having close tolerances for the light emitter and the light receiver was required in practice in order to obtain a device for measuring angular displacement with sufficient precision for professional applications. Such a costly, heavy and voluminous mechanical system is not required in the device according to the present invention. Any deviations between devices mutually or sources or errors that occur in one and the same device in practice when measuring angular displacement no longer contribute towards inaccuracies in the angular displacement measurement carried out by means of the device according to the invention. Consequently, the rotation and bearing system for the mutually rotatable light emitter and light receiver no longer needs to meet exacting requirements, and thus the system can be less costly, leading to a lower cost price of the device according to the invention, which can thus be of more compact design.

Preferably, one embodiment of the device according to the invention is characterised in that the pixels are arranged in a circular pattern on the chip surface, whilst in a special embodiment the light emitter is provided with generally optical means for exposing the pixels to light in a desired light pattern, in which a light streak pattern or possibly a cross-shaped pattern intersects the circular pattern of pixels one or more times.

Advantageously, a chip surface having a surface area of 25 mm² may be used, for example, in which case the circle of the circular pattern may have a diameter of only 4 mm. These properties lie within that which is possible with the current image sensor technology, by means of which it has appeared to be possible to realise a high-resolution device integrated on a silicon chip.

A preferred embodiment of the device according to the invention is characterised in that the light streak pattern comprises at least one light streak which is wider at one end than at the other end.

Since the output signal that is generated upon reading the exposed pixels comprises a narrow portion and a wide portion in that case, this provides information about the orientation (0° or 180° position) of said light streak pattern.

The invention and the method according to the present invention will now be explained in more detail with reference to the figures below, in which like parts are provided with the same numerals. In the figures:

FIG. 1 schematically shows an embodiment of the device according to the invention;

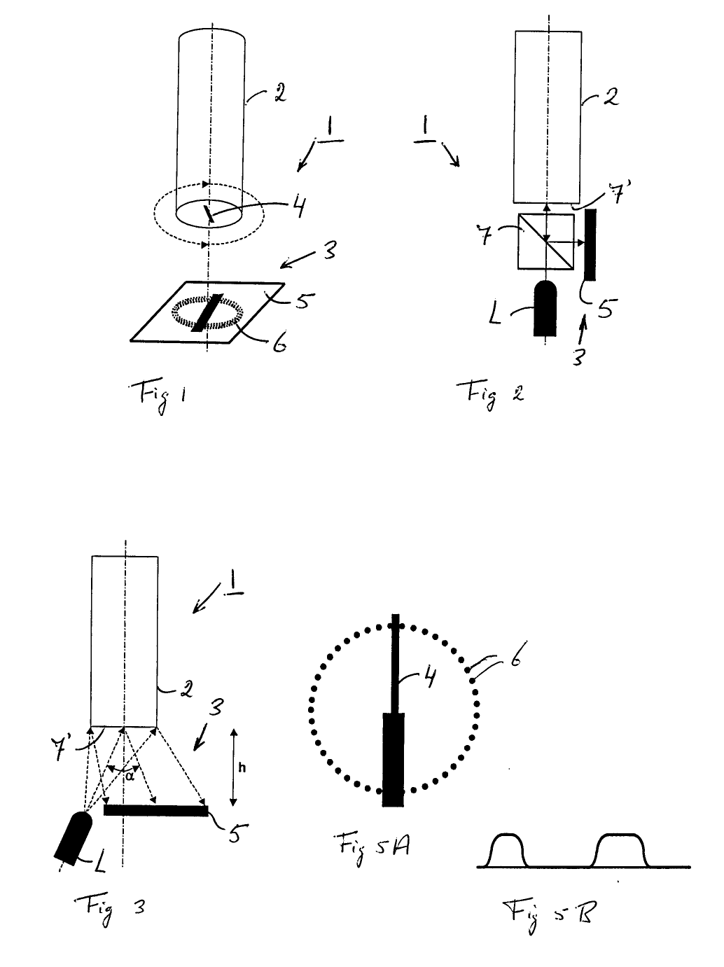

FIG. 2 shows an alternative embodiment of the device according to the invention;

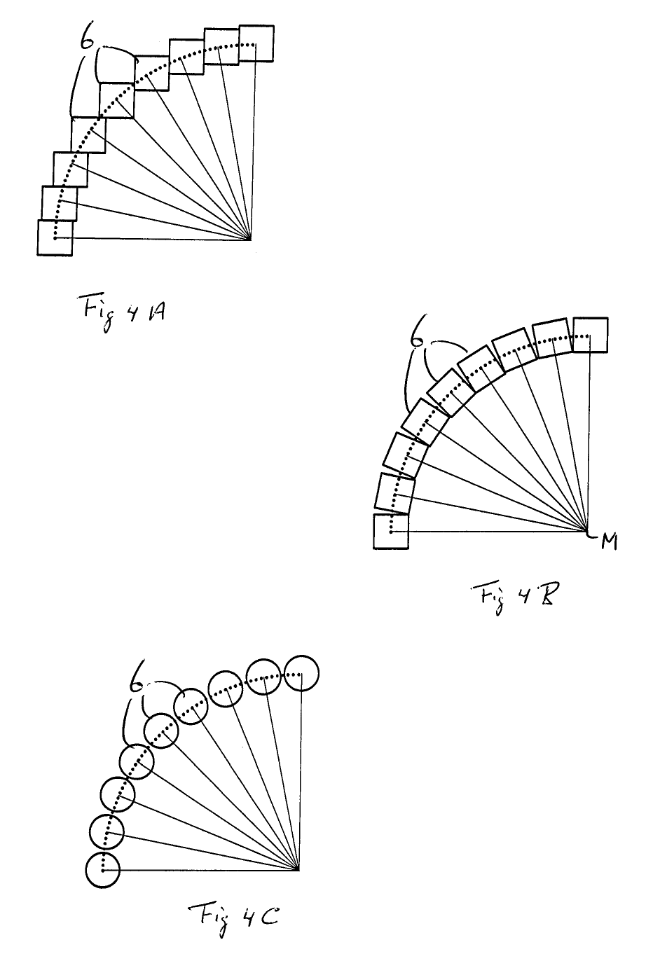

FIG. 3 shows a next alternative embodiment of the device according to the invention; and

FIGS. 4A, 4B and 4C are illustrations of possible circular arc patterns of the pixels in the light receiver according to the invention; and

FIGS. 5A and 5B show an alternative light streak pattern and associated read-out signal of a currently preferred embodiment of the device according to the invention.

FIG. 1 schematically shows a device 1 for measuring angular displacement. The device 1 comprises a light emitter 2 and a light receiver 3, which are angularly rotatable relative to each other through an angle of rotation indicated by a dotted line. In principle both the light emitter 2 and the light receiver 3 may be rotatable in this or in next embodiments of the device 1, but generally only one of the two elements 2, 3 will be rotatably disposed in practice for reasons of constructional simplicity. In the embodiment of FIG. 1 the light emitter part 2 is rotatable, and the light receiver 3, in which a chip is provided, is stationary. In this embodiment a light source, for example a laser diode or LED (L), which emits light having substantially one frequency through a gap 4, is disposed within the light emitter 2. In this case a corresponding light streak pattern is projected onto the surface 5 of the chip in the light receiver 3, on which a circular pattern (in this case) of light-sensitive pixels 6 is present. The light streak pattern intersects the circular pattern twice in this case, although in principle said intersecting may take place only once. If a star-shaped or a cross-shaped pattern is used in the present embodiment or in one of the next embodiments of the device 1, the light pattern will intersect the at least circular arc pattern of pixels 6, which are usually evenly distributed over said pattern, on the chip surface 1 more than once. From the several pixels 6, which may or may not be exposed to light from the light source disposed inside or outside the light emitter 2, information can be derived about the angle or the angular displacement between the light emitter 2 and the light receiver 3. The angular displacement is determined by calculating an optical centre of gravity, using a suitable algorithm, of the group or groups of pixels 6 in the circular arc pattern onto which the light from the light emitter 2 is projected.

An illustration thereof is shown in the embodiment according to FIGS. 5A and 5B. FIG. 5A shows a variant in which the light streak pattern that is projected onto the light-sensitive pixels 6 includes a light streak which is wider at the bottom end, in this case, than at the upper end. As a result, fewer exposed pixels 6 are read at the upper side of the pattern of pixels than at the bottom side, and the read-out signal shown in FIG. 5B will successively be shorter and longer. From the width the orientation, i.e. “the narrow end points upwards”, is derived and after the optical centre of gravity within each of the two bumps in the read-out signal associated with said light streak pattern has been determined it is precisely known which pixels 6 have been exposed at which location and which pixels 6 have not been exposed. Thus the angle or angular displacement angular displacement has been measured with a degree of accuracy that partially depends on the number of pixels 6 provided on the chip.

Any play in the mechanical means (not shown) in which the light emitter 2 and/or the light receiver 3 are mounted for rotation in one of the embodiments of the device 1 explained herein leads to an asymmetrical exposure of the pixels 6 arranged in a circular arc pattern on a chip which can be established upon read-out. As a result, comparatively more pixels will be exposed to the left of the dashed line than to the right of the dashed line when using this single dashed line pattern, which intersects the circular arc twice in FIG. 5A. This asymmetry can be easily corrected in the determination of the optical centre of gravity in the aforesaid bumps, so that such play will not adversely affect the accuracy of the angular displacement measurement.

FIG. 2 shows an alternative embodiment of the device 1. In this embodiment the rotatable light emitter 2, but generally the device 1, is provided with in particular optical means 7 for exposing the pixels 6 in a more precisely defined pattern, usually a light streak pattern or, if desired, a cross pattern or a star pattern. In this embodiment the underside of the light emitter 2 includes a reflective element 7′, which reflects incident light from the fixedly disposed LED L, which is not accommodated within the light emitter in this embodiment, via a semi-transparent prism 7, after which the prism deflects the reflected light 90 degrees to the vertically disposed chip surface 5. Since light is incident on the element 7′ and on the chip surface 5 at right angles, a precisely defined and non-distorted pattern not affected by the angle of incidence is formed on the surface 5 of the compact device 1.

FIG. 3 shows another alternative embodiment of the device 1. In this embodiment the light emitter 2 is provided with optical means 7′, which are reflective. The light from the laser diode L, which is disposed outside the light emitter 2, is reflected—at a total angle α—from the reflective element 7′ mounted to the underside of the light emitter, which generates a light pattern, and projects a light pattern onto the pixels 6 of the chip surface 5. The stationary laser diode L, on which a converging simple lens will be present, will then be positioned beside the surface 5 of the chip, and hardly any tolerance requirements will be made of the light emitter 2. A software-implemented correction may be carried out for the angle α, and in this case the optical means 7′ are of simpler design than those of the embodiment shown in FIG. 2, which does not require such an angle correction, however.

If desired, the LED L may be provided, whether or not together with its control hardware, on the chip on which the circular pattern of pixels is provided. On average the angle α will be practically zero in that case, so that fewer software-implemented corrections are required. On the other hand it will be less easy to connect the light source L if said light source is disposed within a circular pattern of pixels 6, because such a connection slightly disturbs the angular symmetry of the pixels and thus has a slightly adverse effect on the desired even distribution of the light incident on the pixels 6.

There are several, generally point symmetrical alternatives as far as the shape of the individual pixels 6 and the pattern in which the pixels 6 can be provided on the chip surface 5 are concerned, which alternatives are shown in FIGS. 4A, 4B and 4C. Besides a rectangular shape, for example, the pixels preferably have a regular polygonal shape, for example a quadrangular shape, for production reasons, but also a circular shape (FIG. 4C) is possible. Furthermore, the polygonal pixels 6 may be arranged in a patterned in which at least one flat side of the pixel adjoins an adjacent pixel, as shown in FIG. 4B but in particular in FIG. 4A for square pixels. In the latter case the pixels 6 will not be evenly angularly distributed over the circle (circular arc), which fact would have to be taken into account in that case in order to realise a high degree of accuracy of the angle measurement. The pixels 6 may also be arranged in such a pattern on the chip surface 5 that one flat side of each pixel 6 is invariably directed towards the imaginary centre M of the circular pattern (FIG. 4B). Usually the simplicity of the optical means 7 is exchanged for the complexity of the chip grid array and architecture of the light receiver and 3 to be integrated in CMOS.

A standard APS (Active Pixel Sensor) circuit, if desired with multiple sampling, for suppressing the various known types of noise that occur, may be used as a basis for reading the pixels 6 that have or have not been exposed. This hardware and further hardware may advantageously (for reasons of compactness) be provided together with other hardware that may be required, for example for pattern recognition and signal processing, on one and the same chip with the pixels 6 themselves. The same applies with regard to the means which are used for applying interpolation techniques, if required, for reading the exposed pixels, by means of which a high degree of accuracy and resolution of the angular displacement sensor device 1 can be achieved. Furthermore, the hardware required for telemetry applications, for example, which may or may not be provided with programmable IP protocol communication hardware, may be implemented on the same chip.

If an aforesaid cross pattern is projected onto the pixels 6, the circular arc pixel pattern is even simplified to only two circular quadrants.

1. A device for measuring angular displacement, comprising:
a light emitter and a light receiver, which are angularly rotatable relative to each other,
wherein the light receiver comprises light-sensitive pixels arranged in a pattern on a chip surface, on which light from or via the light emitter is incident in dependence on the aforesaid angle of rotation, and wherein said pattern at least forms part of a circular arc pattern.

2. A device according to claim 1, wherein the light emitter is rotatably disposed.

3. A device according to claim 1, wherein the light receiver is stationary disposed.

4. A device according to claim 1, wherein the pixels are evenly distributed over said part of the circular pattern.

5. A device according to claim 1, wherein the pixels are point-symmetrical, in particular regularly polygonal, for example quadrangular, or circular.

6. A device according to claim 5, wherein the quadrangular pixels are arranged in a pattern in which at least one flat side of the pixel adjoins an adjacent pixel.

7. A device according to claim 5, wherein the quadrangular pixels are arranged in a pattern in which at least one flat side of each pixel is directed towards the imaginary centre of the circular pattern.

8. A device according to claim 1, wherein the pixels are arranged in a circular pattern on the chip surface.

9. A device according to claim 1, wherein the light emitter is provided with optical means for exposing the pixels to light in a desired light pattern, for example a light streak pattern or a cross-shaped pattern.

10. A device according to claim 9, wherein the device is arranged for having the light streak pattern intersect the circle 1, 2, 3, 4 or more times.

11. A device according to claim 10, wherein the light streak pattern comprises at least one light streak which is wider at one end than at the other end.

12. A method by which angular displacement between a light emitter and a light receiver which are angularly rotatable relative to each other is measured, comprising:
projecting light emitted by or via the light emitter onto light-sensitive pixels arranged in a pattern on a chip surface in dependence on the aforesaid angle of rotation, and wherein said pattern forms part of a circular arc pattern.

13. A method according to claim 12, wherein the angular displacement is measured by computing an optical centre of gravity of those pixels arranged in said circular arc pattern onto which the light from the light emitter is projected.

14. A light receiver according to claim 1, wherein the light receiver is integrated in a chip, on a surface of which light-sensitive pixels are arranged in a pattern, said pattern forming at least part of a circular arc pattern.
